(19) United States
(12) Patent Application Publication
(10) Pub. No.: US 2014/0207524 A1
(43) Pub. Date: Jul. 24, 2014

(54) SYSTEMS AND METHODS FOR DETERMINING CONSUMER SHOPPING CORRIDORS

(71) Applicant: Richard Just, Berkeley, CA (US)

(72) Inventor: Richard Just, Berkeley, CA (US)

(73) Assignee: CAPITAL ONE FINANCIAL CORPORATION, McLean, VA (US)

(21) Appl. No.: 14/132,995

(22) Filed: Dec. 18, 2013

Related U.S. Application Data
(60) Provisional application No. 61/755,556, filed on Jan. 23, 2013.

(51) Int. Cl. G06Q 30/02

(52) U.S. Cl. CPC G06Q 30/0205
USPC 705/7.34

(57) ABSTRACT

The disclosed embodiments include systems and methods for determining shopping corridor. In one embodiment, a system is disclosed that may include one or more processors and one or more memory devices storing instructions that, when executed by the one or more processors, performs operations consistent with the disclosed embodiments. In one embodiment, the operations may include receiving geo-coded financial transaction data associated with a plurality of financial transactions that were performed using a financial service account associated with a customer. The operations may also include grouping the financial transactions into a plurality of clusters based on the geo-coded financial transaction data. In another aspect, the operations may include generating a shopping corridor associated with the customer based on at least the plurality of clusters, and providing a financial service using the generated shopping corridor.

### PRIORITY CLAIM

This application claims priority under 35 U.S.C. §119 to U.S. Provisional Application No. 61/755,556, filed on Jan. 23, 2013, which is expressly incorporated herein by reference in its entirety.

### TECHNICAL FIELD

The disclosed embodiments generally relate to systems and methods for using financial transaction data and, more particularly, to determining consumer shopping corridors based on financial transaction data.

### BACKGROUND

Current technology provides financial service providers with an abundance of information associated with transactions made by their customers. Each time a customer conducts a transaction, such as a purchase at a retail merchant, their financial service provider typically receives transaction data that describes the transaction. This information is generally compiled and provided to the customer through bank statements and transaction histories.

While storing and providing access to transaction data may allow the customer and/or the financial service provider to review financial activity, it remains tedious and inefficient. Therefore, a need exists for transaction data to be processed in a way that allows customers and financial service providers to view and use transaction data in a more convenient manner.

### SUMMARY

Consistent with disclosed embodiments, systems and methods are provided for determining consumer shopping corridors.

Consistent with a disclosed embodiment, a system for generating a consumer shopping corridor is provided. The system may include one or more processors, and one or more memory devices storing instructions that, when executed by the one or more processors, performs operations that may include receiving geo-coded financial transaction data associated with a plurality transactions that were performed using a financial service account associated with a customer and grouping the financial transactions into a plurality of clusters based on the geo-coded financial transaction data. The operations may also include generating a shopping corridor associated with the customer based on at least the plurality of clusters, and providing a financial service using the generated shopping corridor.

Consistent with another disclosed embodiment, a computer-implemented method for generating a shopping corridor is provided. The computer-implemented method may include receiving geo-coded financial transaction data associated with a plurality of financial transactions that were performed using a financial service account associated with a customer, and grouping the financial transactions, by one or more processors, into a plurality of clusters based on the geo-coded financial transaction data. Grouping the financial transactions may include identifying a geo-coded transaction data parameter associated with the received geo-coded transaction data, and grouping the financial transactions into the plurality of clusters based on the geo-coded transaction data parameter. The computer-implemented method may further include generating, by the one or more processors, a shopping corridor associated with the customer based on at least the plurality of clusters, and using the generated shopping corridor to provide a financial service.

Consistent with another disclosed embodiment, a tangible computer-readable medium storing instructions for representing consumer behavior is provided. The instructions may be operable to cause one or more processors to perform operations consistent with the method described above.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an exemplary system that may be configured to perform one or more processes consistent with disclosed embodiments;

FIG. 2 illustrates another exemplary system for performing one or more processes consistent with disclosed embodiments;

FIG. 3 depicts a flowchart of an exemplary method for determining a shopping corridor consistent with disclosed embodiment;

FIG. 4 depicts a flowchart of an exemplary method for analyzing geo-coded transaction data consistent with disclosed embodiments;

FIG. 5 depicts a flowchart of an exemplary method for determining outlier purchases made by a customer associated with the shopping corridor consistent with disclosed embodiments; and

FIG. 6 depicts a diagram of exemplary uses for a given customer shopping corridor.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include systems and methods for determining a customer shopping corridor. For example, systems and methods consistent with disclosed embodiments may determine where and when a customer makes regular purchases from one or more merchants or otherwise performs financial transactions using one or more financial service accounts provided by a financial service provider. Disclosed embodiments further provide for targeted advertising, cross-sale of products, and/or fraud monitoring based on a consumer's customer shopping corridor information.

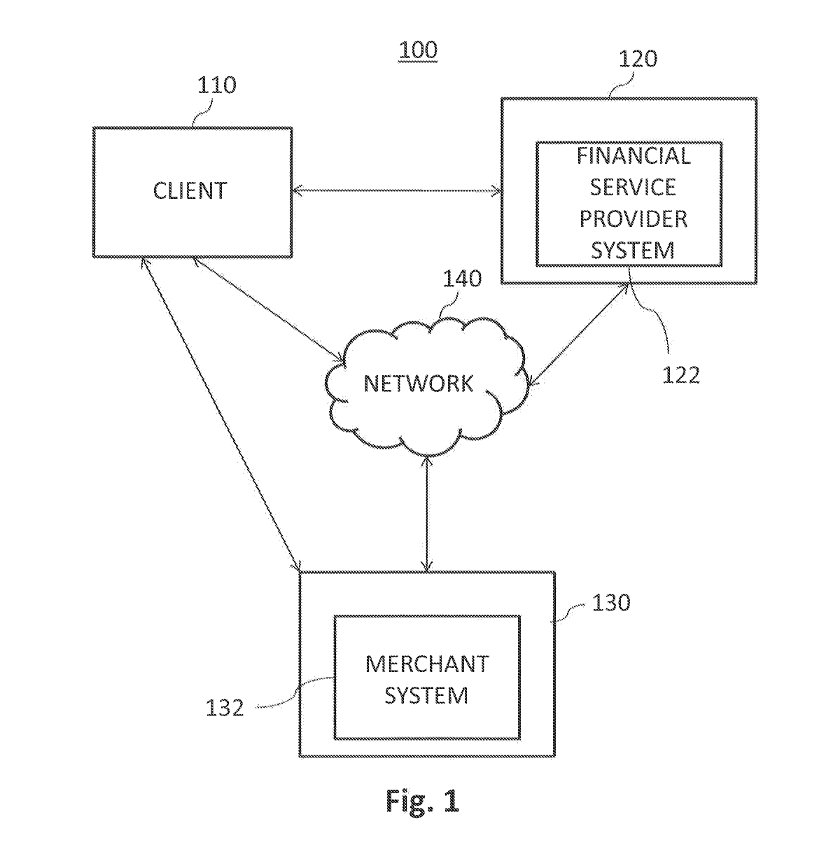

FIG. 1 is a diagram illustrating an exemplary system 100 that may be configured to perform one or more processes consistent with disclosed embodiments. In one aspect, system 100 may be configured to perform processes for determining and using a shopping corridor. In one aspect, system 100 may include a client 110, a financial service provider 120, and a merchant 130, each communicating with a network 140. Client 110 may be connected to financial service provider 120 and merchant 130 directly or via network 140. Financial service provider 120 may be connected to merchant 130 directly or via network 140. Other components known to one of ordinary skill in the art may be included in shopping corridor system 100 to process, transmit, provide, and receive information consistent with the disclosed embodiments.

Client 110 may be one or more computing devices that is configured to perform one or more processes consistent with the disclosed embodiments. In one aspect, client 110 may be associated with a user. In one embodiment, the user may be an individual or entity that performs one or more financial transactions using one or more financial service accounts, such as a credit card account, a checking account, a debit account, a line of credit account, and the like. The user associated with client 110 may have a relationship with financial service provider 120. For example, the user associated with client 110 may be a customer of financial service provider 120. The user or customer associated with client 110 may use a financial service product, such as a debit card or credit card associated with a financial service account provided by financial service provider 120, to purchase items or services. In one embodiment, client 110 may be configured to perform processes that enables the customer to perform electronic purchase transactions, such as online or e-commerce type transactions. The customer associated with client 110 may perform purchase transactions involving the purchase of goods or services from a merchant, such as merchant 130. The transactions may include transactions that take place at a merchant location (e.g., brick and mortar) or electronic purchases, such as online or e-commerce based transactions. The transactions may also include customer transactions at an ATM or at a branch location of financial service provider 120 (e.g., a deposit to an account, a withdrawal from an account, etc.).

In one aspect, client 110 may be one or more computing devices including one or more processing components that perform client device functions, such as a smart phone, a tablet, a laptop, a personal digital assistant, or another form of client device. In one embodiment, client 110 may contain one or more processors, one or more I/O devices, one or more memory devices, and other components. Client 110's memory device(s) may be configured to store information used by the client's processor to perform certain functions related to disclosed embodiments. The memory devices may be volatile or non-volatile, and may be removable. In one embodiment, client 110 may be associated with a user. In certain examples, the user may be a consumer or a potential consumer of financial service provider 120 that provides financial services, such as a bank, credit card company, lender, etc.

Client 110 or a client device may connect to network 140 or other elements of system 100 through the Internet or other communication network(s) and may use one or more protocols, e.g., Universal Serial Bus (USB), Bluetooth, hardware plug-ins, WiFi and other wireless local area network (WLAN) protocols, 3G/4G/LTE and/or other wide area network (WAN) protocols.

Financial service provider 120 may be an entity that provides financial services and financial service accounts, such as a bank, credit card company, etc. In one aspect, financial service provider 120 may include a financial service provider system 122 that is configured to perform financial service type operations and computer-based operations. In certain aspects, financial service provider 120 is referenced in connection with a financial service provider system 122 that is associated with a financial service provider. Thus, in certain aspects, financial service provider 120 may receive and store data related to client 110 transactions. In one embodiment, financial service provider 120 may include one or more computing systems that are located at a central location or may include computing devices that are distributed (locally or remotely). In one example, financial service provider 120 may include a server that is configured to execute software instructions stored in one or more memory devices to perform one or more operations consistent with the disclosed embodiments.

Merchant 130 may be one or more providers of goods and/or services, such as a retailer, etc. Merchant 130 may include one or more computing systems that are configured to perform computer-implemented processes, such as a server, desktop, laptop, mobile device, etc. In one aspect, merchant 130 is described in connection with a merchant system 132. Merchant 130 may provide Internet-based computing devices to market and sell goods and/or services over the Internet (e.g., Web servers, etc.). Merchant 130 may include computing devices to process and handle purchase transactions at a physical location of merchant 130, such as POS terminals, local servers, etc. at a retailer location. Merchant 130 may be configured to perform financial transaction processes, such as receiving, processing, and handling purchase transactions, payment processes, etc. associated with the sale of goods and/or services provided by merchant 130. In certain aspects, the customer associated with client 110 may purchase goods and/or services from merchant 130 using a financial service account provided by financial service provider 120. Payment processes associated with transactions involving merchant 130 and client 110 (or the customer associated with client 110) may involve communications over network 140.

Network 140 may comprise any type of computer networking arrangement used to exchange data. For example, network 140 may be the Internet, a private data network, or a virtual private network using a public network such as the Internet. Network 140 may also include a public switched telephone network (“PSTN”) and/or a wireless network.

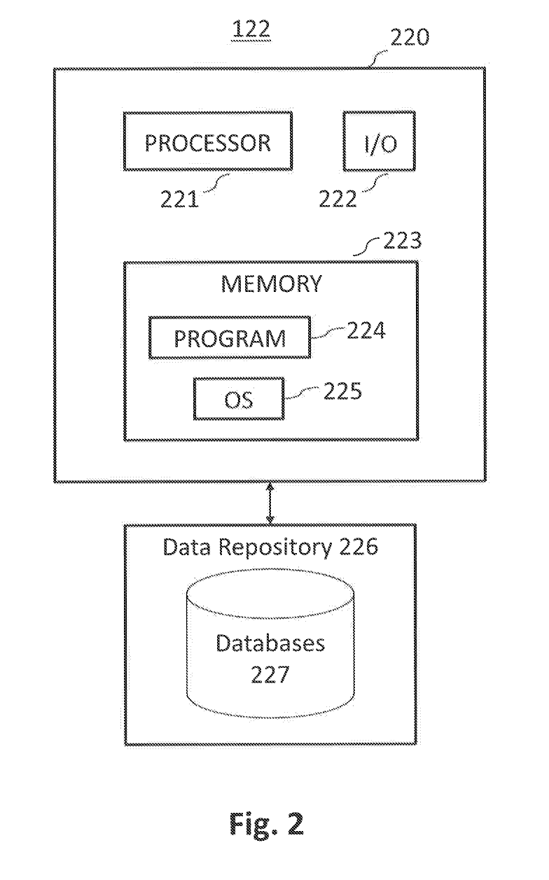

FIG. 2 shows an exemplary financial service provider system 122 that may be associated with financial service provider 120. In one embodiment, the system may include one or more servers 220 having one or more processors 221, one or more memories 223, and one or more input/output (I/O) devices 222. Alternatively, server 220 may take the form of a general purpose computer, a mainframe computer, or any combination of these components. Server 220 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. Processor 221 may be configured to execute software instructions stored in memory, such as memory 223. The disclosed embodiments are not limited to the type and configuration of processor 221.

Memory 223 may include one or more storage devices configured to store instructions used by processor 221 to perform functions related to disclosed embodiments. For example, memory 223 may be configured with program 224 that performs one or more operations relating to the disclosed embodiments when executed by processor 221. The disclosed embodiments are not limited to implementing separate programs or computers configured to perform one or more operations, tasks, etc. For example, program 224 may represent a single software program that performs one or more functions when executed by processor 221. Alternatively, program 224 may comprise multiple programs that work independently or collectively to perform one or more operations consistent with the disclosed embodiments. Additionally, processor 221 may execute one or more software programs located remotely from server 220. For example, financial service provider system 122 may access one or more remote software programs that, when executed, perform one or more operations consistent with disclosed embodiments. The disclosed embodiments are not limited to any configuration, number, and/or format of program 224, or any software instructions executed by processor 221.

In one embodiment, memory 223 may also be configured with operating system software 225 that performs, when executed by one or more processors (e.g., processor 221) well known operating system operations. By way of example, the operating system may be Microsoft Windows™, Unix™, Linux™, Solaris™, or some other operating system. The choice of operating system, and even the use of an operating system, is not critical to any disclosed embodiment.

I/O devices 222 may be one or more devices that are configured to allow data to be received and/or transmitted by server 220. I/O devices 222 may include one or more digital and/or analog communication devices that allow server 220 to communicate with other machines and devices, such as customers associated with client 110.

Server 220 may also be communicatively connected to one or more data repositories 226 as shown in FIG. 2, Server 220 may be communicatively connected to data repositories 226 through network 140. Data repository 226 may include one or more files or databases 227 that store information and are accessed and/or managed through server 220. By way of example, databases 227 may be Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider 120 may include data repository 226. Alternatively, data repository 226 may be located remotely from financial service provider 120. Further, server 220 may include data repository 226 and/or database(s) 227.

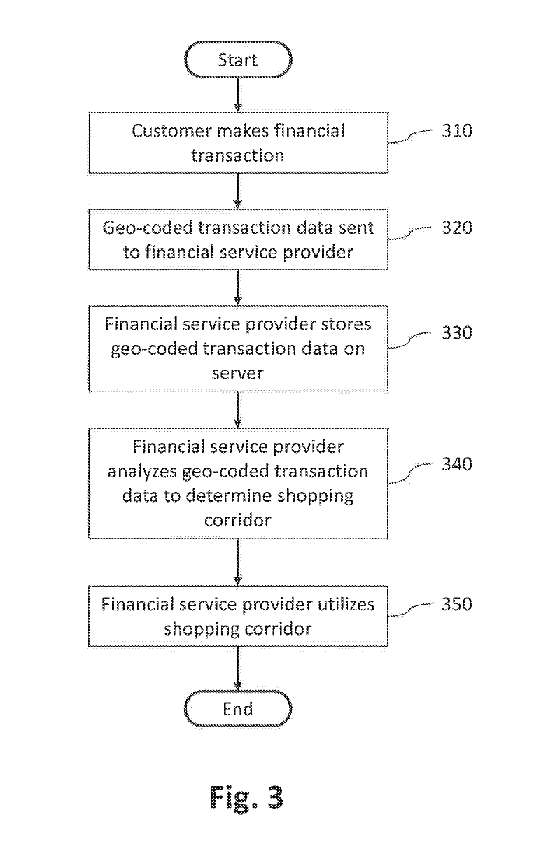

FIG. 3 shows a flowchart of an exemplary process for determining a shopping corridor consistent with disclosed embodiments. In one aspect, FIG. 3 is described in connection with determining a shopping corridor for a customer associated with client 110. The customer may be a customer that has a financial service account(s) provided by financial service provider 120.

In one aspect, a shopping corridor may include a representation of geographic locations in which a customer may be likely to make future transactions. The shopping corridor may be derived from a database of past transactions associated with the customer. The database may be organized by one or more parameters related to the transactions. For example, financial service provider system 122 may generate a virtual “map” that organizes the customer transactions based on location information associated with each transaction. The database may also include further organization based on time information associated with each transaction. (These parameters will be described in more detail below.) Financial service provider 120 may utilize the organized database to identify geographic locations in which the customer commonly makes transactions, as well as pathways through the identified locations (i.e., connecting roads). These locations and pathways may represent one or more shopping corridors associated with client 110.

In accordance with disclosed embodiments, a customer may perform a financial transaction (step 310). The transaction may involve client 110 and a merchant 130. In certain embodiments, the financial transaction may include, for example, one or more purchase transactions that take place at a physical location of merchant 130, one or more purchase transactions via an online merchant 130 (e.g., online transactions involving a Web site provided by one or more servers associated with merchant 130), one or more Automated Teller Machine (ATM) transactions (e.g., fund withdrawal, account status check, bill payment, deposit transaction, etc.), one or more financial service transactions that takes place at a physical location of financial service provider 120, such as, for example, a branch of financial service provider 120 (e.g., fund withdrawal, bill payment, deposit transaction, account status check, etc. at a branch location of a bank), one or more financial service transactions (e.g., fund withdrawal, bill payment, deposit transaction, account status check, etc.) involving an online banking system associated with financial service provider 120 (e.g., a Web site that provides financial services for customers of financial service provider 120), one or more transactions involving the use of a mobile application, such as for example, where client 110 is a mobile device (e.g., smart phone, tablet, etc.) that executes a mobile application that allows the customer to perform one or more transactions (e.g., online banking transactions, purchases, etc.), and the like.

The disclosed embodiments include transactions that may occur in-person or over the internet. A purchase transaction may include a credit card, check card, or debit card type transaction. In certain aspects, the customer may use client 110 to perform a transaction involving a financial service account (e.g., credit card account, checking account, etc.). For example, client 110 may execute software processes that provide information relating to the financial service account to a POS terminal or to an online e-commerce server over the Internet. The financial service account information may be inputted to client 110 by the customer. Alternatively, client 110 may be configured to store the financial service account information for use by client 110 during purchase transactions (e.g., direct (e.g., POS based) or remote (e.g., online type transactions)).

In certain embodiments, financial service provider 120 may be configured to generate, collect, determine, and/or receive geo-coded transaction data associated with client 110 transactions (e.g., debit or credit card purchases at a merchant 130). The geo-coded transaction data may be sent directly from client 110 or merchant 130, or through a third-party source, such as a credit card processor (e.g. Visa, MasterCard, etc.). Geo-coded transaction data may include information related to a financial transaction, such as the transaction the customer performed in step 310. In one aspect, geo-coded transaction data may include, for example, time information relating to a time when the financial transaction was performed (e.g., when a purchase transaction was initiated, completed, or processed for payment, etc.), date information relating to a date when the financial transaction was performed (e.g., information reflecting the day, month, year, and/or day of week, etc.), fund amount information relating to a monetary amount involved in the financial transaction (such as, for example, the purchase amount for a purchase transaction, the deposit amount for a deposit transaction, a withdrawal amount for a withdrawal transaction, etc.), location information relating to the location of where the financial transaction occurred, such as for example, geographic location information (e.g., city, state, country, zip code, etc.) of a merchant 130 where the customer performed a purchase transaction, of financial service provider 130 location (e.g., bank branch), of the customer's location when performing an online financial transaction (e.g., online banking, online purchase, etc.), and the like.

In other aspects, geo-coded transaction data may include a web address of the web site that was involved in an electronic online transaction, such as an online banking transaction (e.g., financial service provider web site transaction), an e-commerce purchase (e.g., merchant web site purchase), etc. It is also contemplated that financial service provider 120 may receive location information from client 110 for some transactions, instead of through merchant 130. For instance, client 110 may be configured to perform software processes that generate the geo-coded transaction data based on information relating to the financial transaction and/or client 110. For example, client 110 may receive transaction data relating to the financial transaction, such as amount of transaction (e.g., purchase amount), item or service line item identification data, time of transaction, location. GPS data relating to the location of client 110 at the time of the transaction, etc.). Client 110 may receive the transaction data from merchant 130 involved with the financial transaction. Client 110 may also execute software processes that collect profile information relating to client 110 or the customer. For instance, client 110 may collect GPS information relating to the current location of client 110 at the time of the transaction. Client 110 may use the transaction data and/or client profile information to generate the geo-coded transaction data, which may be sent to financial service provider 120 to be stored with any description information received from merchant 130 or a third party source (e.g., credit card processer) known to be associated with the same transaction.

In one aspect, client 110 may store the geo-coded transaction data in a memory included in client 110. Further, client 110 or merchant 130 may be configured to execute software processes that send the geo-coded transaction data to financial service provider 120 (step 320). In one embodiment, client 110 may send the geo-coded transaction data to server 220 of financial service provider 120. Client 110 may send the data via network 140 or another communication mechanism.

Client 110 may be configured to send the geo-coded transaction data to server 220 based on one or more conditions or in response to one or more events. For example, client 110 may send geo-coded transaction data for a given transaction to server 220 at the time that the transaction was performed (e.g., in response to client 110 determining that the transaction was performed). In one aspect, client 110 may be configured to execute software that determines when a financial service account associated with the customer is used to perform the financial transaction. In response to the determination, client 110 may generate and send the geo-coded transaction data to server 220.

In another embodiment, client 110 may send the geo-coded transaction data to server 220 at a time after the financial transaction has occurred. For example, the disclosed embodiments may enable the customer associated with client 110 to upload data relating to the financial transaction to server 220 using software executed on client 110. Alternatively, client 110 may execute software processes that automatically send the geo-coded transaction data to server 220 based on a condition. For example, client 110 may be configured to send geo-coded transaction data to server 220 after a certain period of time after a financial transaction. In another example, client 110 may automatically send the transaction data periodically. Client 110 may collect, store, and send batches of geo-coded transaction data relating to multiple financial transactions.

In certain embodiments, client 110 may generate transaction data that does not include geographic location information. Instead, client 110 may determine and send geographic location (e.g., GPS location of client 110 or merchant 130) to server 220 separate from the transaction data. Client 110 may send the geographic location information at a separate time as when the transaction data is sent, or as a separate packet of information along with the transaction data. The geographic location information may be supplied by another source, such as a GPS device associated with client 110 at the time of the transaction or information supplied by a social media site (e.g. Facebook, Twitter, etc.).

After transaction description information has been received (via one or more of the exemplary processes described above, or other process), financial service provider 120 may execute a software process to derive latitude and longitude coordinates from the location information received from each client 110 transaction. For example, the software process may match description information of a given transaction, such as merchant name, city, zip code, or street address, against a database of merchants with known geographic locations to make a prediction on the physical location in which the transaction took place. Financial service provider system 122 may store the latitude and longitude coordinates associated with each transaction for use in creating the customer shopping corridor.

In certain embodiments involving online financial transactions (e.g., a Web site related purchase transaction), geographic location information may be unnecessary. In other embodiments, client 110 may determine and send transaction type information reflecting the type of the financial transaction (e.g. website purchase, mobile application transaction, etc.). Client 110 may include transaction type information in the geo-coded transaction data.

In step 330, financial service provider 120 may store the geo-coded transaction data, including derived latitude and longitude coordinates, on server 220. In step 340, financial service provider 120 may analyze geo-coded transaction data stored on server 220 to determine a shopping corridor for a customer (e.g., the customer associated with client 110). The shopping corridor may be a representation or database of geographic locations in which the customer has made transactions in the past and is likely to make future transactions, and pathways that connect the geographic locations where additional transactions may be made. In step 350, financial service provider 120 may use the determined shopping corridor associated with the customer. For example, financial service provider 120 may use the shopping corridor to generate targeted advertisement suggestions or as part of fraud prevention services.

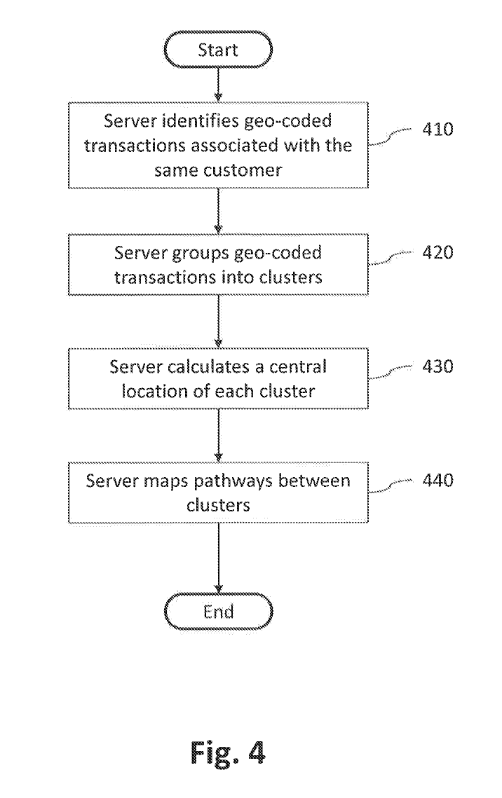

FIG. 4 depicts a flowchart of an exemplary process for determining a shopping corridor. In one aspect, the process of FIG. 4 may be performed by server 220. Server 220 may receive geo-coded transaction data for multiple financial transactions and for multiple customers, and may be configured to store the transaction data in a memory. In step 410, server 220 may identify geo-coded transactions associated with the same customer (e.g., a customer associated with client 110). In one aspect, server 220 may identify associated geo-coded transactions by identifying each transaction associated with a certain financial service account or associated with a specific customer relating to a financial service account. Server 220 may use, for example, the financial service account information relating to the financial service account used to perform financial transactions recorded in the geo-coded transactions.

In step 420, server 220 may group the geo-coded transactions associated with the customer into clusters using a preferred clustering algorithm. In one embodiment, each cluster may represent a particular geographic location or geographic area where the customer (and/or client 110) has made a significant number of purchases (e.g., above a certain threshold number). A cluster may represent, for example, an area around the customer's home (e.g., 1 mile radius around the customer's home address), an area around a customer's place of work (e.g., a ½ mile radius around the customer's place of work address), a retailer location (e.g., a shopping mall, shopping plaza, merchant location, etc.), and the like.

In step 430, server 220 may calculate a central location for each cluster. In one aspect, server 220 may calculate the central location by calculating a central latitude and longitude associated with each cluster.

In step 440, server 220 may map one or more pathways between each cluster. Server 220 may use the geo-coded transaction data to determine the one or more pathways. For example, server 22 may use time and date information of each transaction to identify movement between one or more clusters. Server 220 may also use outlier transactions to find transaction locations a certain distance from one or more of the clusters.

Server 220 may be configured to execute software that identifies a flow through each cluster by client 110 based on the pathways. For example, a first cluster may represent a geographic location near the customer's home and a second cluster may represent a location near the customer's place of work. Based on time and date information relating to the transactions in the first and second clusters, server 220 may determine that, during a weekday, client 110 made purchases near home in the mornings (e.g., coffee or breakfast) and purchases near work in the afternoons (e.g., lunch). Server 220 may further identify an outlier purchase that may exist somewhere between the customer's work and home. The outlier may further specify a pathway that identifies the customer's movement between the clusters of home and work.

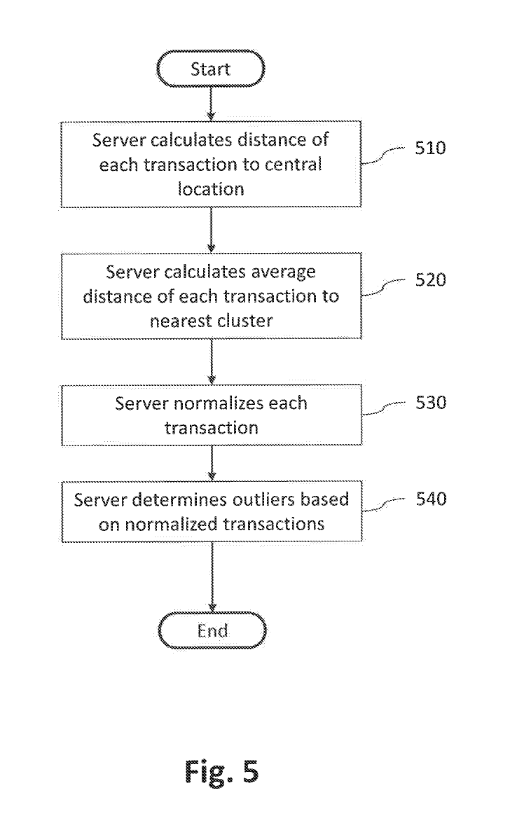

FIG. 5 depicts a flowchart of an exemplary process for determining outlier purchases made by a customer. Server 220 may be configured to execute software processes that perform one or more of the process steps of FIG. 5.

In step 510, server 220 may calculate the distance of each transaction to the central location (e.g., determined in step 430) of the nearest cluster. In step 520, server 220 may calculate an average distance of each transaction to their nearest cluster. In step 530, server 220 may normalize the transactions. In step 540, server 220 may use the normalized transactions to determine outliers. Outlier purchases may include one-off purchases that are not part of established purchase patterns for the customer. These may include, for example, out-of-town purchases (e.g., purchases in locations a certain distance away (e.g., far away) from established clusters), a purchase on a day or at a time when the customer does not usually make purchases (based on, for example, historical transaction history information that server 220 may analyze), a purchase from a merchant that the customer had not purchased from previously (based on information that server 220 may analyze), and the like.

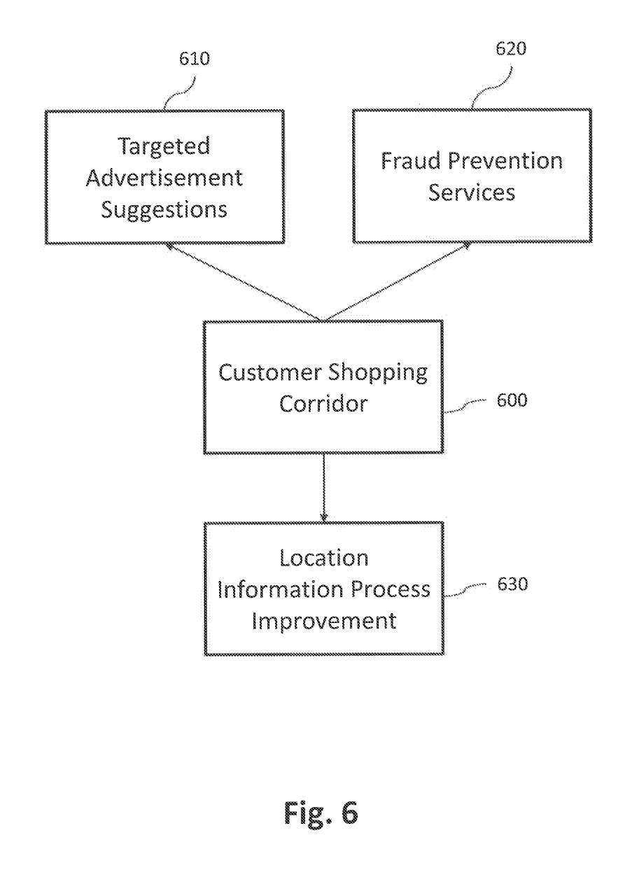

FIG. 6 is a diagram illustrating exemplary manners in which financial service provider 120 or another entity may utilize a customer shopping corridor 600. After a customer shopping corridor 600 has been determined, financial service provider 120 may use the information to generate targeted advertisement suggestions 610 for client 110 or directly to an associated customer. For example, financial service provider may utilize server 220 to execute software that determines a customer interest value for one or more merchants 130 based on historical transaction data associated with customer shopping corridor 600. Server 220 may determine that a customer may have interest in a merchant based on, for example, the merchant's location in relation to transaction clusters in the shopping corridor associated with the customer. Server 220 may also determine that a customer may have interest in a merchant based on whether the merchant is a determined competitor to one or more merchants 130 in transaction clusters in the shopping corridor associated with the customer. Based on the customer interest value, server 220 may generate targeted advertisement suggestions to be sent to client 110.

It is further contemplated that shopping corridor 600 may be utilized as part of a fraud prevention service 620. New transactions may be matched against known shopping corridors for a given customer to make a prediction of the likelihood that the new transaction is fraudulent. Financial service provider 120 may utilize server 220 to execute software instructions that compares the new transaction to customer shopping corridor 600 to determine whether the transaction is likely valid or likely fraudulent. For example, if server 220 determines that the transaction is an outlier transaction, server 220 may analyze the characteristics associated with the transaction to determine whether it is fraudulent. For example, server 220 may determine that the characteristics of the transactions reflect characteristics of likely fraudulent transactions for the customer (e.g., the transaction was performed within a certain time period of one or more other transaction, the location of the transaction (e.g., new, far away, etc.). In one aspect, server 220 may store in a memory a data structure including fraudulent characteristic information reflecting possible fraudulent activities or parameters that server 220 may use in predicting transaction validity.

Another exemplary use (630) of customer shopping corridor 600 includes improving analysis of transaction descriptions for other customer transactions. Information from a customer shopping corridor 600, such as clusters around a customer's home or work, may be utilized as a predictive tool for new transactions. If a transaction description associated with a new transaction is unclear (e.g., lacking sufficient location information, incomplete merchant description, etc.) it may be difficult to accurately predict the actual merchant 130 with which the transaction was made, when multiple possible merchants meet description criteria. It is contemplated that financial service provider 120 may utilize server 220 to execute software that determines which, if any, of possible merchants are located within a customer shopping corridor. The additional information may allow server 220 to more accurately predict the correct merchant and merchant location of a transaction (i.e., if a possible merchant is in a customer shopping corridor, it is more likely to be the correct merchant over another possible merchant that is not in the shopping corridor.).

The methods and systems consistent with the disclosed embodiments are not limited to the examples described herein. Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. For example, the disclosed embodiments may execute software processes that can generate or determine shopping corridors that have varying characteristics. For instance, the disclosed embodiments may generate a shopping corridor for a customer based on various criteria. In one embodiment, the disclosed embodiments may generate a shopping corridor associated with in-person transactions (e.g., transactions that are performed at a physical location, such as at a bank, at a merchant location, etc.). The disclosed embodiments may also generate a shopping corridor for the customer that is related to “online” transactions, such as Internet purchases, or online banking transactions. An online shopping corridor may utilize time and date information in combination with a customer's online “movement” (e.g., visited websites, internet searches). In another aspect, the disclosed embodiments may generate shopping corridors representing different types of transactions. For example, the disclosed embodiments may generate shopping corridors that are associated with, for example restaurants, retail stores, service providers (e.g., financial service providers, utility providers, etc.), recreational activities, ATM locations, and any other type of activity or merchant.

1. A system for generating a consumer shopping corridor comprising:
one or more processors; and
one or more memory devices storing instructions that, when executed by the one or more processors, performs the operations of:
receiving geo-coded financial transaction data that includes:
a plurality of financial transactions performed using a financial service account associated with a customer, and
location information corresponding to the plurality of financial transactions;
grouping the financial transactions into a plurality of clusters based on the location information;
generating a shopping corridor associated with the customer based on at least the plurality of clusters; and
providing a financial service using the generated shopping corridor.

2. The system of claim 1, wherein
the location information indicates a location of the customer for each of the plurality of financial transactions when each of the plurality of financial transactions occurred.

3. The system of claim 1, wherein the one or more processors execute the instructions to perform operations further comprising:
estimating a pathway between at least two geographic areas that each correspond to a cluster of the plurality of clusters, based at least on time and date information corresponding to the plurality of financial transactions.

4. The system of claim 3, wherein the pathway predicts customer movement between the at least two geographic areas.

5. The system of claim 1, wherein each of the plurality of clusters corresponds to a geographic area.

6. The system of claim 5, wherein at least one cluster of the plurality of clusters corresponds to a geographic area around at least one of the customer's home, the customer's place of work, or a retailer location.

7. The system of claim 1, wherein the provided financial service includes a targeted advertisement service or a fraud prevention service.

8. The system of claim 1, wherein the financial service includes determining outlier purchases made by the customer as an indicator of fraud.

9. The system of claim 8, wherein determining outlier purchases includes:
calculating a central location of each of the plurality of clusters;
normalizing each of the plurality of financial transactions based on a corresponding calculated central location, and
determining outlier purchases based on the normalized financial transactions.

10. The system of claim 1, wherein the location information includes latitude and longitude information corresponding to each of the plurality of financial transactions.

11. A computer-implemented method for generating a consumer shopping corridor, comprising:
receiving geo-coded financial transaction data that includes:
a plurality of financial transactions that were performed using a financial service account associated with a customer, and
location info ation corresponding to the plurality of financial transactions and indicating a location of the customer for each of the plurality of financial transactions when each of the plurality of financial transactions occurred;
grouping, by one or more processors, the financial transactions into a plurality of clusters based on the location information;
generating, by the one or more processors, a shopping corridor associated with the customer based on at least the plurality of clusters; and
providing a financial service using the generated shopping corridor.

12. (canceled)

13. The computer-implemented method of claim 11, wherein generating a shopping corridor includes estimating a pathway between two or more geographic areas that each correspond to a cluster of the plurality of clusters, based at least on time and date information corresponding to the plurality of financial transactions.

14. The computer-implemented method of claim 11, wherein the financial service is a targeted advertisement service and wherein providing the service includes providing an advertisement based on a merchant located in the shopping corridor.

15. The computer-implemented method of claim 11, wherein the financial service is a fraud prevention service and wherein providing the service includes determining an outlier transaction.

16. The computer-implemented method of claim 11, wherein the financial service includes predicting a merchant associated with a financial transaction based on the determined shopping corridor.

17. A non-transitory computer-readable medium storing instructions that, when executed by a processor, cause the processor to perform the operations comprising:
receiving geo-coded financial transaction data that includes:
a plurality of financial transactions performed using a financial service account associated with a customer, and
location information corresponding to the plurality of financial transactions;
grouping the financial transactions into a plurality of clusters based on the location information;
generating a shopping corridor associated with the customer based on at least the plurality of clusters; and
providing a financial service using the generated shopping corridor.

18. The non-transitory computer-readable medium of claim 17, wherein
the location information indicates a location of the customer for each of the plurality of financial transactions when each of the plurality of financial transactions occurred.

19. The non-transitory computer-readable medium of claim 17, wherein the instructions cause the processor to perform operations further comprising:
estimating a pathway between at least two geographic areas that each correspond to a cluster of the plurality of clusters based, at least on time and date information corresponding to the plurality of financial transactions.

20. The non-transitory computer-readable medium of claim 17, wherein each of the plurality of clusters corresponds to a geographic area.

21. The system of claim 1, wherein the shopping corridor includes geographic areas in which the customer has made financial transactions and pathways connecting the geographic areas.

22. The system of claim 21, wherein providing the financial service includes using the geographic areas and pathways as an indicator of a likelihood that the customer will make a future financial transaction at a merchant.

23. The system of claim 1, wherein providing the financial service includes determining a customer interest value for the one or more merchants based on the shopping corridor, and generating targeted advertisement suggestions based on the customer interest value.
